(19) United States
(12) Patent Application Publication
(10) Pub. No.: US 2009/0224651 A1
(43) Pub. Date: Sep. 10, 2009

(54) PHOSPHOR MIXTURE AND PLASMA DISPLAY PANEL COMPRISING THE PHOSPHOR MIXTURE

(76) Inventors: Hyun-Deok Lee, Suwon-si (KR); Ick-Kyu Choi, Suwon-si (KR); Do-Hyung Park, Suwon-si (KR); Ji-Hyun Kim, Suwon-si (KR); Kyu-Chan Park, Suwon-si (KR); Mi-Ran Song, Suwon-si (KR); Yu-Mi Song, Suwon-si (KR); Min-Ju Kim, Suwon-si (KR); Yoon-Chang Kim, Suwon-si (KR); Jay-Hyok Song, Suwon-si (KR); Young-Hun Lee, Suwon-si (KR)

Correspondence Address: CHRISTIE, PARKER & HALE, LLP, PO BOX 7068, PASADENA, CA, 91109-7068, US

(21) Appl. No.: 12/398,121

(22) Filed: Mar. 4, 2009

(30) Foreign Application Priority Data
Mar. 5, 2008 (KR) 10-2008-0020568

(51) Int. Cl. H01J 63/04; C09K 11/78

(52) U.S. Cl. 313/485; 252/301.4 R

(57) ABSTRACT

Phosphor mixtures for phosphor layers of plasma display devices are provided. The phosphor mixture includes a first compound selected from compounds represented by Gd_{1-y}Tb_{y}Al₃(BO₃)₄ (0.05≦Y≦0.8) and compounds represented by YBO₃:Tb³⁺, and a second compound represented by Zn(Ga_{1-X}Alₓ)₂O₄:Mn²⁺ (0.2≦X≦0.8). The first compound and second compound are mixed in a weight ratio ranging from about 3:7 to about 6:4. The inventive phosphor mixtures exhibit reduced decay times, thereby increasing color reproducibility and improving brightness characteristics.

### CROSS-REFERENCE TO RELATED PATENT APPLICATION

This application claims priority to and the benefit of Korean Patent Application No. 10-2008-0020568, filed on Mar. 5, 2008 in the Korean Intellectual Property Office, the entire content of which is incorporated herein in by reference.

### BACKGROUND OF THE INVENTION

1. Field of the Invention

The present invention relates to phosphor mixtures and plasma display panels comprising the phosphor mixtures.

2. Description of the Related Art

Display apparatuses can be classified into emissive type displays that emit light themselves and non-emissive type displays that use an additional lamp. The non-emissive type displays include liquid crystal displays (LCDs), and the emissive type displays include plasma display panels (PDPs), cathode ray tubes (CRTs), and organic light emitting diodes (OLEDs).

The emissive type displays include phosphors which can be classified into light emission type (PL) phosphors, cathode ray emission type (CL) phosphors, and field emission type (EL) phosphors. Plasma display panels have recently received much attention as emissive type displays which use light emission type phosphors.

In order to realize and emissive type full color display, red, green, and blue colors of light are used. Of the three colors of light, the green color of light plays the most important role for realizing an image. This is because the human eye photonic response has peak sensitivity at approximately 535 nm (a green component of the visible spectrum).

### SUMMARY OF THE INVENTION

According to one embodiment of the present invention, a phosphor mixture increases color reproducibility and increases luminous efficiency, thereby increasing brightness characteristics by reducing the decay time.

In another embodiment of the present invention, a plasma display panel includes the phosphor mixture.

According to an embodiment of the present invention, a phosphor mixture includes a first compound represented by Chemical Formula 1 or 2 below, and a second compound represented by Chemical Formula 3 below. The first compound and the second compound are mixed in a weight ratio ranging from about 3:7 to about 6:4.

Gd_{1-y}Tb_{y}Al₃(BO₃)₄ (0.05≦Y≦0.8) Chemical Formula 1

YBO₃:Tb³⁺ Chemical Formula 2

Zn(Ga₁₋ₓAlₓ)₂O₄:Mn²⁺ (0.2≦X≦0.8) Chemical Formula 3

According to another embodiment of the present invention, a plasma display panel includes a first substrate and a second substrate facing each other, a phosphor layer disposed in a discharge space between the first substrate and the second substrate, a discharge electrode to which a voltage is applied to generate a discharge in the discharge space, and a discharge gas injected in the discharge space, wherein the phosphor layer includes a phosphor having a first compound represented by Chemical Formula 1 or 2 above and a second compound represented by Chemical Formula 3 above mixed in a weight ratio ranging from about 3:7 to about 6:4.

### BRIEF DESCRIPTION OF THE DRAWINGS

The above and other features and advantages of the present invention will become more apparent by reference to the following detailed description when considered in conjunction with the attached drawing in which:

FIG. 1 is a partial cutaway exploded perspective view of a plasma display panel according to an embodiment of the present invention.

### DETAILED DESCRIPTION OF THE INVENTION

The present invention will now be described with reference to the accompanying drawings in which exemplary embodiments of the invention are shown.

### Phosphor Mixture

A phosphor mixture according to an embodiment of the present invention generates green light, and is made by mixing a first compound represented by Chemical Formula 1 or 2 and a second compound represented by Chemical Formula 3 in a weight ratio ranging from about 3:7 to about 6:4.

Gd_{1-y}Tb_{y}Al₃(BO₃)₄ (0.05≦Y≦0.8) Chemical Formula 1

YBO₃:Tb³⁺ Chemical Formula 2

Zn(Ga₁₋ₓAlₓ)₂O₄: Mn²⁺ (0.2≦X≦0. 8) Chemical Formula 3

If the weight ratio is less than about 3:7, for example, the weight ratio is 2:8 etc., the decay time is 9 ms or more, and thus luminous efficiency is reduced. The decay time directly affects the luminous efficiency. That is, the shorter the decay time, the higher the luminous efficiency, and accordingly, the brightness of a corresponding display apparatus can be increased. Also, the decay time directly affects a latent image and/or a flicker phenomenon. The longer the decay time, the more severe the latent image and/or the flicker phenomenon, thereby reducing the reliability of the display apparatus. Thus, the weight ratio must not be less than about 3:7.

If the weight ratio exceeds about 6:4, for example, 7:3, 8:2 etc., color reproducibility is reduced, and thus, desired image quality cannot be realized.

A phosphor mixture according to one embodiment of the present invention can be formed by mixing the first compound of Chemical Formula 1 or 2 with the second compound of Chemical Formula 3 in a weight ratio ranging from about 3:7 to about 6:4.

The compound of Chemical Formula 3 can be manufactured using the following method. A phosphor mother-body is formed by mixing a zinc compound, a gallium compound, and an aluminum compound in a mixing ratio that satisfies the conditions of Chemical Formula 3. The compounds that constitute the phosphor mother-body can be nitrates, acetates, chlorides, oxides, carbonates, or sulfides. Powders of the compounds that constitute the phosphor mother-body are mixed, and then, the powders are doped with Mn, which is an activator. Afterwards, the first compound of Chemical Formula 3 can be manufactured according to a well known solid-state reaction by annealing the powders. In another embodiment, the compound can be manufactured using spray pyrolysis instead of the solid-state reaction. These methods of manufacturing the compound of Chemical Formula 3 are well known.

Also, a compound of Chemical Formula 1 can be manufactured by the following method. That is, a phosphor mother-body is formed by mixing a gadolinium compound, a terbium compound, an aluminum compound, and a boric acid compound in a mixing ratio that satisfies the conditions of Chemical Formula 1, and is annealed in the same manner as the compound of Chemical Formula 3.

Thus, the phosphor mixture according to one embodiment can be manufactured by mixing a first compound represented by Chemical Formula 1 (manufactured as described above) and the second compound represented by Chemical Formula 3 in a weight ratio ranging from about 3:7 to about 6:4.

Also, the phosphor mixture according to another embodiment of the present invention can be manufactured by mixing a first compound represented by Chemical Formula 2 and a second compound of Chemical Formula 3 in a weight ratio ranging from about 3:7 to about 6:4.

The compound of Chemical Formula 2 can be manufactured such that, after a phosphor mother-body is formed by mixing a yttrium compound and a boric acid compound in a mixing ratio that satisfies the conditions of Chemical Formula 2, the phosphor mother-body is doped with terbium, and then annealed in the same manner as the compound of Chemical Formula 3.

Thus, the phosphor mixture according to another embodiment of the present invention can be manufactured by mixing a first compound of Chemical Formula 2 and a second compound of Chemical Formula 3 in a weight ratio ranging from about 3:7 to about 6:4.

A green phosphor mixture can be manufactured by mixing the above phosphor mixtures with a phosphor selected from Zn₂SiO₄:Mn, BaMgAl₁₀O₁₇:Mn, BaMgAl₁₂O₁₉:Mn, and Li₂ZnGe₃O₈:Mn.

### Plasma Display Panel

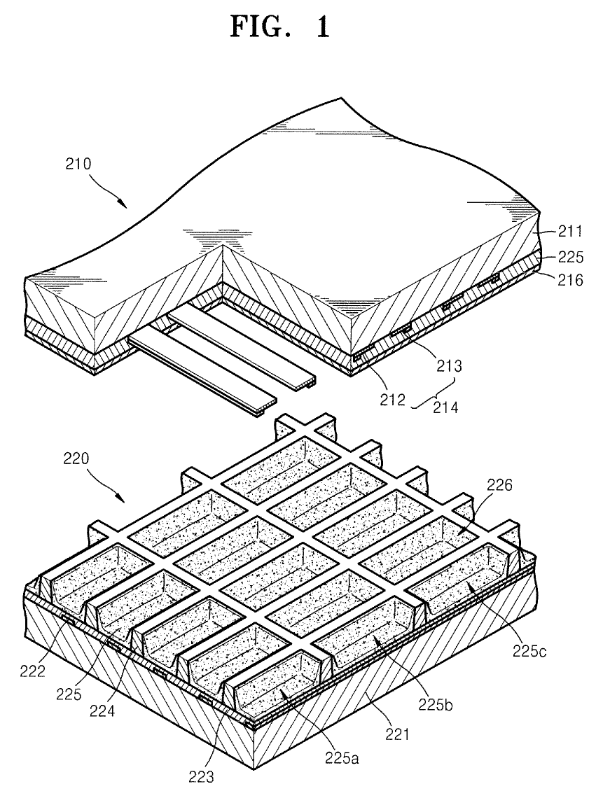

FIG. 1 is a cutaway exploded perspective view of a plasma display panel (PDP) according to an embodiment of the present invention. A three-electrode surface discharge type plasma display panel is shown, however, the present invention is not limited thereto. That is, the plasma display panel may be any plasma display panel on which a phosphor layer can be disposed.

Referring to FIG. 1, the PDP according to one embodiment includes a front panel 210 and a rear panel 220. The front panel 210 includes a first substrate 211, a plurality of sustain electrode pairs 214 disposed parallel to each other on the first substrate 211, a first dielectric layer 215 covering the sustain electrode pairs 214, and a protective film 216.

The rear panel 220 includes a second substrate 221 disposed facing the first substrate 211, a plurality of address electrodes 222 disposed on the second substrate 221 generally perpendicular to the sustain electrode pairs 214, a second dielectric layer 223 covering the address electrodes 222, and a barrier rib structure 224 disposed in a matrix shape on the second dielectric layer 223.

When the front panel 210 and the rear panel 220 are combined, a lower part of the barrier rib structure 224 contacts the second dielectric layer 223 and an upper part of the barrier rib structure 224 contacts the first dielectric layer 215. Thus, the barrier rib structure 224 defines a discharge space between the first substrate 211 and the second substrate 221 forming a plurality of discharge cells 226. In one embodiment, the discharge cells 226 have a rectangular shape since the barrier rib structure 224 is disposed in a matrix shape.

Phosphor layers 225 are disposed in the discharge cells 226. More specifically, the PDP according to one embodiment includes red phosphor layers 225a, green phosphor layers 225b, and blue phosphor layers 225c.

Each red phosphor layer 225a includes a red phosphor, nonlimiting examples of which include (Y,Gd)BO₃:Eu, or Y(V,P)O₄:Eu. Each blue phosphor layer 225c includes a blue phosphor, nonlimiting examples of which include BaMgAl₁₀O₁₇:Eu or CaMgSi₂O₆:Eu.

Each green phosphor layer 225b includes a phosphor mixture in which the first compound of Chemical Formula 1 or 2 and the second compound of Chemical Formula 3 are mixed in a weight ratio ranging from about 3:7 to about 6:4. If the first and second compounds are mixed in a weight ratio less than about 3:7, for example, 2:8, 1:9 etc., the decay time can be 9 ms or more. The decay time directly affects the luminous efficiency of the phosphor, and if the decay time is greater than 9 ms, the luminous efficiency cannot reach a level useful in a display product. Also, the decay time of the phosphor affects the flicker phenomenon, which is noticeable to the viewer. In particular, if the decay time is greater than 9 ms, the display product cannot be used since the flicker phenomenon will increase the viewer's eye fatigue.

Also, if the first and second compounds are mixed in a weight ratio exceeding about 6:4, that is, 7:3 or 8:2 etc., the color reproducibility of the display apparatus is greatly reduced. In a PDP having high color reproducibility, the green phosphor has an x color coordinate value of 0.2589 and a y color coordinate value of 0.6884. In the case of the green phosphor, the color reproducibility increases as the x coordinate value is lowered and the y coordinate value is increased. Therefore, in order to produce a PDP having high color reproducibility, the x coordinate value should be below 0.2598 and the y coordinate value should be greater than 0.6884. This is standard for the green phosphor to widen the range of color reproducibility. The color reproducibility range is an area value calculated from the area of a color coordinate system triangle formed from the color coordinates of the red, green and blue phosphors. The area of the triangle can be increased by minimizing the x coordinate value of the green phosphor and maximizing the y coordinate value of the green phosphor. Thus, the green phosphor mixture according to embodiments of the present invention includes the first compound of Chemical Formula 1 or 2 and the second compound of Chemical Formula 3 mixed in a weight ratio not exceeding about 6:4.

The phosphor layer 225 can be formed by first forming a phosphor paste, and coating the phosphor paste in the discharge cells 226. Then, the phosphor paste is dried and sintered. The phosphor paste can be formed by mixing the phosphor with a binder resin and a solvent. In particular, a green phosphor paste can be manufactured by mixing the phosphor mixture including the first compound of Chemical Formula 1 or 2 and the second compound of Chemical Formula 3 in a weight ratio ranging from about 3:7 to 6:4 with a binder resin and a solvent.

The binder resin can be a cellulose group resin, an acryl group resin, or a mixture of these resins. Nonlimiting examples of suitable cellulose group resins include methyl cellulose, ethyl cellulose, propyl cellulose, hydroxy methyl cellulose, hydroxy ethyl cellulose, hydroxy propyl cellulose, hydroxy ethyl propyl cellulose, and combinations thereof. Nonlimiting examples of suitable acryl group resins include methacrylate group materials (such as poly methyl methacrylate, poly isopropyl methacrylate, and poly isobutyl methacrylate), polymers of acryl group monomers (such as methyl methacrylate, ethyl methacrylate, propyl methacrylate, butyl methacrylate, hexyl methacrylate, 2-ethyl hexyl methacrylate, benzyl methacrylate, dimethyl amino ethyl methacrylate, hydroxy ethyl methacrylate, hydroxy propyl methacrylate, hydroxy butyl methacrylate, phenoxy 2-hydroxy propyl methacrylate, glycidyl acrylate, methyl acrylate, ethyl acrylate, propyl acrylate, butyl acrylate, hexyl acrylate, 2-ethyl hexyl acrylate, benzyl acrylate, dimethyl amino ethyl acrylate, hydroxyl ethyl acrylate, hydroxy propyl acrylate, hydroxy butyl acrylate, phenoxy 2-hydroxy propyl acrylate, glycidyl acrylate), and combinations thereof. In some cases, the mixture can include a small amount of inorganic binder. The content of the binder resin can range from about 2 to about 8 parts by weight based on 100 parts by weight of the phosphor paste.

The solvent can be an alcohol group, an ether group, an ester group, or a mixture of these materials. In one embodiment, the solvent is selected from butyl cellusolve (BC), butyl carbitol acetate (BCA), terpineol, and combinations thereof. If the content of the solvent is too high or too low, the flowability characteristic of the mixture is not appropriate, and thus, the process for forming the green phosphor layer may not be straightforward. Accordingly, the content of the solvent in the phosphor paste may range from about 25 to about 75 parts by weight based on 100 parts by weight of the phosphor paste.

The phosphor paste can further include other additives for improving flowability characteristics and processing characteristics. The additives can be, for example, photosensitizer (e.g., benzophenone), dispersing agents, defoamers, leveling agents, plasticizers, and anti-oxidants. These additives can be used alone or in combination, and are commercially available.

After the phosphor is mixed and stirred with a binder resin and a solvent, the phosphor paste is coated on the discharge cells 226. The coated phosphor paste is dried at a temperature ranging from about 120 to about 140° C., and then sintered at a temperature ranging from about 200 to about 600° C. for from about 1 to about 4 hours, thereby forming the phosphor layer 225.

A discharge gas is filled in the discharge cells 226. The discharge gas can be, for example, a Ne—Xe gas mixture containing from about 5 to about 10% Xe. As necessary, at least a portion of the Ne can be replaced with He.

Hereinafter, evaluation results of decay time, light emission characteristics, and color reproducibility of phosphor mixtures according to embodiments of the present invention will be provided.

### Evaluation 1 Decay Time Evaluation

Gd_{0.6}Tb_{0.4}Al₃(BO₃)₄ and Zn(Ga_{0.5}Al_{0.5})₂O₄:Mn²⁺ were mixed in various weight ratios as summarized in Table 1, and decay times were measured. A green phosphor including Zn_{2SiO}₄:Mn²⁺ and YBO₃:Tb mixed in a weight ratio of 80:20 was used for comparison.

TABLE 1

| Gd_{0.6}Tb_{0.4}Al₃(BO₃)₄ | Zn(Ga_{0.5}Al_{0.5})₂O₄:Mn²⁺ | Decay time (ms) |
|---|---|---|
| 100 | 0 | 4 |
| 80 | 20 | 6.1 |
| 70 | 30 | 6.5 |
| 60 | 40 | 7.0 |
| 40 | 60 | 8.1 |
| 30 | 70 | 8.7 |
| 20 | 80 | 9.4 |
| 0 | 100 | 10.2 |

| | |
|---|---|
| Comparative phosphor | 7.6 |

Referring to Table 1, it can be seen that as the content of Zn(Ga_{0.5}Al_{0.5})₂O₄:Mn²⁺ increases, the decay time increases. In particular, it is seen that when Gd_{0.6}Tb_{0.4}Al₃(BO₃)₄ and Zn(Ga_{0.5}Al_{0.5})₂O₄:Mn²⁺ are mixed in a weight ratio of 20:80, the decay time exceeds 9 ms. Accordingly, in order to reduce the decay time below 9 ms, the weight ratio of Gd_{0.6}Tb_{0.4}Al₃(BO₃)₄ and Zn(Ga_{0.5}Al_{0.5})₂O₄:Mn²⁺ should not exceed about 30:70.

### Evaluation 2 Light Emission Characteristic Evaluation

Light emission characteristics of the phosphors listed in Table 1 were measured. More specifically, relative brightness and brightness saturation were measured. The relative brightness was measured (calculated) by comparing the values of phosphors in a conventional PDP, and brightness saturation was calculated by measuring brightness while increasing sustain frequencies. The results are shown in Table 2 below.

As a result, it is seen that the phosphor mixtures according to embodiments of the present invention have increased brightness saturation compared to the comparative phosphor while the inventive phosphor mixtures have brightness levels generally equivalent to the comparative phosphor. Thus, it can be seen that the phosphor mixtures according to embodiments of the present invention can increase brightness saturation characteristics without reducing brightness, thus increasing panel brightness and sensitivity when the phosphor mixtures are applied to PDPs.

TABLE 2

| | | Relative | Brightness |
|---|---|---|---|
| | | Brightness | saturation |
| Gd_{0.6}Tb_{0.4}Al₃(BO₃)₄ | Zn(Ga_{0.5}Al_{0.5})₂O₄:Mn²⁺ | (%) | (%) |
| 100 | 0 | 101 | 92 |
| 80 | 20 | 100 | 92 |
| 70 | 30 | 99 | 92 |
| 60 | 40 | 99 | 91 |
| 40 | 60 | 97 | 90 |
| 30 | 70 | 96 | 90 |
| 20 | 80 | 96 | 89 |
| 0 | 100 | 94 | 88 |

| | | |
|---|---|---|
| Comparative group | 100 | 81 |

### Evaluation 3 Color Reproducibility Evaluation

Color reproducibilities of the phosphors listed in Table 1 were measured, and the results are summarized in Table 3. The lower the x coordinate value and the higher the y coordinate value in a color coordinate, the higher the color reproducibility of the green phosphor. Thus, a phosphor mixture can have color reproducibility equal to or greater than that of the comparative group by including Gd_{0.6}Tb_{0.4}Al₃(BO₃)₄ and Zn(Ga_{0.5}Al_{0.5})₂O₄:Mn²⁺ in a weight ratio not exceeding about 60:40.

TABLE 3

| Composition | | CIE coordination | |
|---|---|---|---|
| Gd_{0.6}Tb_{0.4}Al₃(BO₃)₄ | Zn(Ga_{0.5}Al_{0.5})₂O₄:Mn²⁺ | x | y |
| 100 | 0 | 0.3365 | 0.5871 |
| 80 | 20 | 0.2966 | 0.6226 |
| 70 | 30 | 0.2767 | 0.6404 |
| 60 | 40 | 0.2567 | 0.6581 |
| 40 | 60 | 0.2169 | 0.6935 |
| 30 | 70 | 0.1970 | 0.7112 |
| 20 | 80 | 0.1770 | 0.7290 |
| 0 | 100 | 0.1371 | 0.7645 |

| | | |
|---|---|---|
| Comparative group | 0.2597 | 0.6884 |

Overall, from the evaluations, the phosphor mixtures according to embodiments of the present invention, in which Gd_{0.6}Tb_{0.4}Al₃(BO₃)₄ and Zn(Ga_{0.5}Al_{0.5})₂O₄:Mn²⁺ are mixed in a weight ratio ranging from about 3:7 to about 6:4, have greatly improved relative brightness and brightness saturation, and thus can be used as the green phosphor. The phosphor mixtures also have high color reproducibility and can increase luminous efficiency by having a reduced decay time. The reduction in decay time can prevent the flicker phenomenon and/or latent image problem.

As described above, the phosphor mixtures according to embodiments of the present invention are used as green phosphors. In one embodiment, the phosphor mixture includes Gd_{0.6}Tb_{0.4}Al₃(BO₃)₄ and Zn(Ga_{0.5}Al_{0.5})₂O₄:Mn²⁺ mixed in a weight ratio ranging from about 3:7 to about 6:4, and exhibits a decay time of 9 ms or less, thereby increasing luminous efficiency and preventing latent image and/or flicker phenomena when used in a display apparatus. Also, with regard to color reproducibility, since the phosphor mixture can effectively realize a green color, the phosphor mixture can be used in emissive display apparatuses, in particular, in plasma display apparatuses.

In the above evaluations, green phosphors in which x is 0.5 and y is 0.4 are described, however, the present invention is not limited to these green phosphors. Indeed, other green phosphors, including Zn(Ga₁₋ₓAlₓ)₂O₄:Mn²⁺ (0.2≦x≦0.8) and Gd_{1-y}Tb_{y}Al₃(BO₃)₄ (0.05≦y≦0.8) exhibit similar and/or better effects as the green phosphors of the above evaluations.

Also, green phosphors including YBO₃ and Zn(Ga₁₋ₓAlₓ)₂O₄:Mn²⁺ in weight ratios ranging from 3:7 to 6:4 have decay times of 9 ms or less, and can as effectively represent the green color with color reproducibility as the phosphors including Zn(Ga₁₋ₓAlₓ)₂O₄:Mn²⁺ and Zn(Ga_{0.5}Al_{0.5})₂O₄:Mn²⁺.

While the present invention has been illustrated and described with reference to certain exemplary embodiments, it is understood by those of ordinary skill in the art that various changes and modifications to the described embodiments may be made without departing from the spirit and scope of the present invention as defined by the following claims.

What is claimed is:

1. A phosphor mixture comprising:
a first compound selected from the group consisting of compounds represented by Chemical Formula 1 and compounds represented by Chemical Formula 2,
Gd_{1-y}Tb_{y}Al₃(BO₃)₄ where 0.05≦Y≦0.8 Chemical Formula 1
YBO₃:Tb³⁺ Chemical Formula 2
a second compound represented by Chemical Formula 3;
Zn(Ga₁₋ₓAlₓ)₂O₄:Mn²⁺ where 0.2≦X≦0.8; and Chemical Formula 3
wherein the first compound and the second compound are mixed in a weight ratio ranging from about 3:7 to about 6:4.

2. The phosphor mixture of claim 1, wherein the phosphor mixture generates green light.

3. A plasma display panel comprising:
a first substrate and a second substrate;
at least one phosphor layer in a discharge space between the first substrate and the second substrate, wherein at least one of the at least one phosphor layer comprises a phosphor mixture comprising:
a first compound selected from the group consisting of compounds represented by Chemical Formula 1 and compounds represented by Chemical Formula 2,
Gd_{1-y}Tb_{y}Al₃(BO₃)₄ where 0.05≦Y≦0.8 Chemical Formula 1
YBO₃:Tb³⁺ Chemical Formula 2
a second compound represented by Chemical Formula 3;
Zn(Ga₁₋ₓAlₓ)₂O₄:Mn²⁺ where 0.2≦X≦0.8; and Chemical Formula 1
wherein the first compound and the second compound are mixed in a weight ratio ranging from about 3:7 to about 6:4;
a discharge electrode adapted to receive a voltage for generating a discharge in the discharge space; and
a discharge gas in the discharge space.

4. The plasma display panel of claim 3, wherein the discharge space defines a plurality of discharge cells, and wherein the at least one phosphor layer comprising the phosphor mixture is a green phosphor layer, the green phosphor layer being in some of the discharge cells.

5. The plasma display panel of claim 3, wherein the discharge space defines a plurality of discharge cells, and wherein the at least one phosphor layer comprises at least one red phosphor layer, at least one green phosphor layer, and at least one blue phosphor layer, the red, green and blue phosphor layers being in separate discharge cells, wherein the at least one phosphor layer comprising the phosphor mixture is the at least one green phosphor layer.

6. A plasma display panel comprising:
a first substrate and a second substrate;
at least one red phosphor layer in a discharge space between the first substrate and the second substrate;
at least one blue phosphor layer in a discharge space between the first substrate and the second substrate;
at least one green phosphor layer in a discharge space between the first substrate and the second substrate, wherein the at least one green phosphor layer comprises a phosphor mixture comprising:
a first compound selected from the group consisting of compounds represented by Chemical Formula 1 and compounds represented by Chemical Formula 2,
Gd_{1-y}Tb_{y}Al₃(BO₃)₄ where 0.05≦Y≦0.8 Chemical Formula 1
YBO₃:Tb³⁺ Chemical Formula 2
a second compound represented by Chemical Formula 3;
Zn(Ga₁₋ₓAlₓ)₂O₄:Mn²⁺ where 0.2≦X≦0.8; and Chemical Formula 3
wherein the first compound and the second compound are mixed in a weight ratio ranging from about 3:7 to about 6:4;
a discharge electrode adapted to receive a voltage for generating a discharge in the discharge space; and
a discharge gas in the discharge space.
